(19) United States
(12) Patent Application Publication
(10) Pub. No.: US 2025/0308374 A1
(43) Pub. Date: Oct. 2, 2025

(54) Multi-Sensor Firearm Shot Detection and Analysis System

(71) Applicants: Benjamin William Swedberg, Cave Creek, AZ (US); Sean David Corry, Olalla, WA (US)

(72) Inventors: Benjamin William Swedberg, Cave Creek, AZ (US); Sean David Corry, Olalla, WA (US)

(21) Appl. No.: 19/093,122

(22) Filed: Mar. 27, 2025

Related U.S. Application Data
(60) Provisional application No. 63/571,335, filed on Mar. 28, 2024.

(51) Int. Cl. G08B 29/18; F41A 35/00; G01P 15/18; G01S 3/801

(52) U.S. Cl. CPC G08B 29/188; F41A 35/00; G01P 15/18; G01S 3/801

(57) ABSTRACT

A multi-sensor shot detection system and method for accurately identifying and recording gunfire initiated by a user while filtering out ambient gunshots in shared shooting environments. The system integrates motion and acoustic sensors, with data fused into a unified feature vector and processed using a trained classification model to identify valid shot events in real time. The device includes an adaptive calibration process to tune detection parameters to specific firearms and user characteristics. Sensor data is processed locally and may include biometric, environmental, and location-based inputs. Processed event records are stored and synchronized with external applications to support advanced analytics and long-term performance tracking. The system is deployable in wearable and firearm-mounted configurations, enabling high-accuracy detection and context-aware feedback across various use cases.

### CROSS-REFERENCE TO RELATED APPLICATIONS

This application claims the benefit of U.S. Provisional Patent Application No. 63/571,335, filed on Mar. 28, 2024, under 35 U.S.C. § 119 (e).

### PRIOR ART

U.S. Pat. No. 7,688,679, “Gunshot Detection Sensor with Display” (Filed: Oct. 24, 2007).

This patent describes a wearable acoustic sensor system for gunshot detection with individual displays for users. It includes GPS receivers, a host processor, and a communication network to deliver gunfire location information directly to sensor wearers.

U.S. Pat. No. 10,401,380, “Wearable System for Accelerometer-Based Detection and Classification of Firearm Use” (Filed: May 14, 2015).

This patent discloses a wearable gunshot detection system using accelerometers to detect and classify firearm use, with features for tamper detection and communication with remote monitoring systems.

U.S. Pat. No. 10,424,048, “Systems and Methods Involving Creation and/or Utilization of Image Mosaics in Classification of Acoustic Events” (Granted: Sep. 24, 2019). ShotSpotter's patent covers converting audio event features into visual displays, which are then compiled into an image mosaic. These mosaics can be used in conjunction with deep learning neural networks for gunshot classification.

U.S. Pat. No. 11,417,183, “Cable-Free Indoor Gunshot Detection” (Filed: Jun. 27, 2019). This patent by Shooter Detection Systems describes battery-powered, cable-free indoor gunshot detection sensors intended for indoor environments.

U.S. Pat. No. 10,657,800, “Gunshot Detection in an Indoor Environment” (Filed: Aug. 23, 2017).

This patent covers techniques for indoor gunshot detection using multiple sensors, including acoustic and infrared sensors, to distinguish gunshots from other events (e.g., fire alarm strobes).

US Patent Application 2014/0218518, “Firearm Discharge Detection and Response System” (Filed: Feb. 4, 2014).

This application describes a system that uses arrays of sensors to detect gunshots. It further includes communication interfaces to controllers and provides alerts to building occupants and authorities.

### Summary of Prior Art and Disclaimer

Various gunshot detection systems have been proposed, as outlined above. While these solutions rely on acoustic or motion sensing, none appear to disclose or claim a single device integrating both acoustic and motion sensors for attachment to a user or firearm. As a result, current approaches may lack the combined accuracy and real-time analytical capabilities made possible by fusing data from multiple sensor types in one wearable or firearm-mounted unit. The present invention addresses these shortcomings by enabling a fused sensor platform designed specifically to detect and analyze user-initiated firearm discharges in real time. Unless expressly stated otherwise, nothing in the foregoing discussion of the prior art is admitted to be prior art to the present application.

### BACKGROUND OF THE INVENTION

Accurate shot detection and analysis are critical in firearm training, competitive shooting, and tactical environments where performance must be measured objectively. Conventional shot timers and firearm monitoring systems often rely on single-sensor approaches, such as microphones or inertial sensors, which are prone to false positives-especially in shared environments like shooting ranges.

These systems generally cannot differentiate between gunfire initiated by the user and nearby shooters, leading to unreliable timing data and incorrect event attribution. Moreover, many lack the ability to capture biometric, environmental, or contextual data that would enable in-depth performance analytics. Some systems are platform-specific or require fixed installation, limiting adaptability across shooting styles and environments.

There remains a need for a portable, sensor-rich system capable of accurately detecting user-initiated gunfire, filtering out ambient noise, and collecting meaningful event data for analysis. An ideal solution would be adaptable to various firearm platforms, support wearable or mounted deployment, and offer real-time feedback and long-term tracking capabilities through external applications.

### SUMMARY OF THE INVENTION

The present invention provides a multi-sensor shot detection device configured to accurately identify gunfire initiated by the user while filtering out ambient gunshots in environments with multiple shooters. The system integrates motion sensors (e.g., accelerometers) and sound sensors to capture data in parallel, which is fused into a single feature vector and processed in real time by trained classification models. These models run on an embedded microprocessor and are capable of distinguishing user-initiated shots from external gunfire with high accuracy.

To support diverse firearm types and user preferences, the device is designed for flexible deployment. It may be worn on the user's dominant wrist for optimal motion sensitivity or mounted directly to a firearm via industry-standard interfaces such as M-LOK or Picatinny rails. The housing is compact, rugged, and adaptable to a variety of form factors, including wristbands, clips, or integrated firearm components.

The system incorporates an adaptive calibration process that guides the user through test shots and sensor analysis to fine-tune detection thresholds, model weights, and environmental filters. This enables accurate performance across different users, firearms, and environmental conditions.

Sensor data—including motion, sound, biometric, environmental, and optional GPS inputs—is processed locally and stored in internal memory. Data can be synchronized with an external application via wireless communication, enabling advanced analytics such as session review, performance tracking, and drill evaluation. In some embodiments, the device may also include a display for presenting shot timing, configuration options, or training feedback.

By combining multi-sensor fusion, embedded machine learning, and calibration-based personalization, the invention provides a comprehensive, real-time shot detection platform suitable for recreational, competitive, law enforcement, and military applications.

### BRIEF DESCRIPTION OF DRAWINGS

FIG. 1 is a system overview diagram illustrating the main components of the multi-sensor shot detection system.

FIG. 2 is a perspective view of the wearable embodiment of the shot detection device worn on the user's wrist.

FIG. 3 is a perspective view of the firearm-mounted embodiment of the shot detection device mounted directly to a firearm.

FIG. 4 is a data flow diagram showing how information is processed within the shot detection system to identify a gunshot.

FIG. 5 is a diagram illustrating multiple sensor inputs and their correlation in the gunshot identification process.

FIG. 6 is a flowchart illustrating the adaptive calibration process for tuning detection parameters based on firearm type and user-specific characteristics.

### DETAILED DESCRIPTION OF THE INVENTION

The present invention relates to a multi-sensor shot detection device configured to accurately identify and record gunfire initiated by the user while filtering out ambient gunfire in multi-shooter environments. The device addresses limitations in conventional shot timers and firearm training tools by implementing sensor fusion techniques, real-time processing, and advanced classification models. Applications include, but are not limited to, recreational shooting, competitive marksmanship, law enforcement, and military training.

Current shot detection systems often rely on single-sensor approaches, such as acoustic microphones or inertial sensors, which are prone to false positives and cannot reliably distinguish between user-initiated shots and external gunfire in shared shooting environments. The present invention overcomes these limitations by combining motion and sound data in a synchronized manner, allowing for context-aware event detection and precise shot attribution.

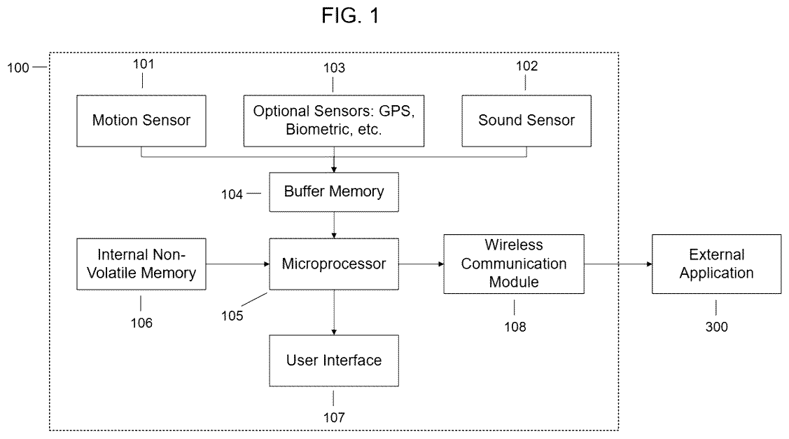

As illustrated in FIG. 1, the system includes a rugged, environment-resistant housing (100) that contains the core functional components. These include one or more motion sensors (101), such as accelerometers and/or gyroscopes, for capturing movement across multiple axes; one or more sound sensors (102), such as microphones or MEMs sound sensors, for acoustic data collection; and optional auxiliary sensors (103) for capturing biometric, environmental, or geolocation data. A buffer memory (104) temporarily stores raw sensor data for processing, while a microprocessor (105) executes real-time data fusion and classification algorithms. Internal non-volatile memory (106) stores processed event records and feature data for later synchronization.

The housing may also include a user interface (107), such as a screen and input buttons, allowing the user to interact with the device, configure settings, or review shooting data. A wireless communication module (108) supports low-energy data exchange with an external computing device (300), such as a smartphone or tablet running a companion application.

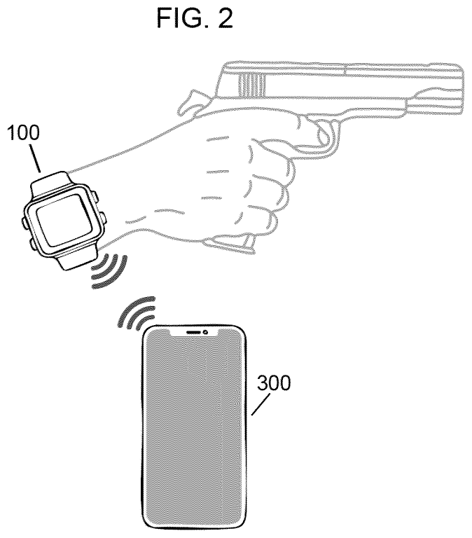

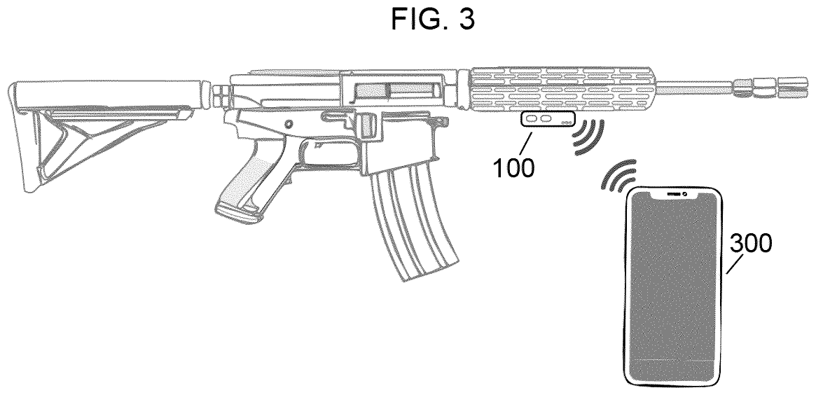

Referring to FIG. 2, the device may be worn on the user's wrist, particularly the dominant wrist, to maximize sensitivity to firearm recoil during operation. FIG. 3 illustrates an alternative embodiment in which the device is mounted directly to a firearm via standard attachment systems such as M-LOK or Picatinny rails. The housing is designed for durability, modularity, and adaptability to suit a range of user preferences and operational needs.

These physical configurations enable the system to function effectively across a variety of use cases and firearm platforms. Whether worn by the user or integrated into a weapon system, the invention provides a robust and adaptable solution for accurate shot detection and performance tracking in real-world scenarios.

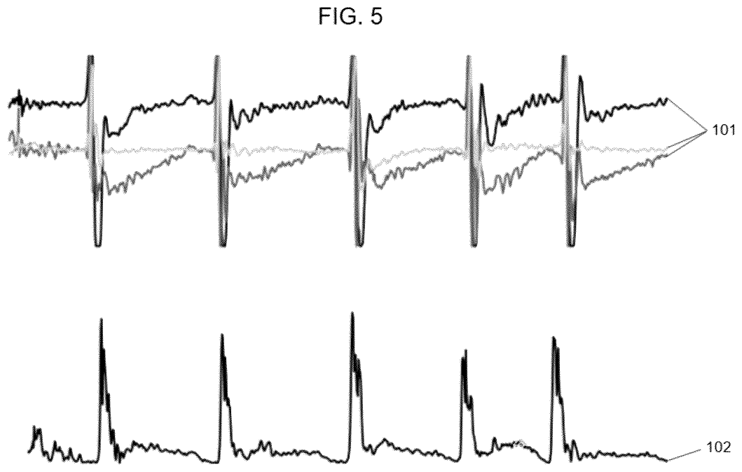

The core functionality of the device centers on its shot detection methodology, which fuses motion and acoustic sensor data to accurately identify firearm discharges initiated by the user while filtering out ambient gunfire. As illustrated in FIG. 5, this sensor fusion approach allows for synchronized analysis of motion patterns and acoustic signatures, thereby enhancing accuracy in multi-shooter environments. Motion sensors (101) continuously monitor for sudden acceleration spikes and recoil patterns characteristic of firearm discharge. These events typically exhibit acceleration magnitudes ranging from 3 to 16 G for handguns, and up to 20 G for rifles, depending on firearm type and user handling.

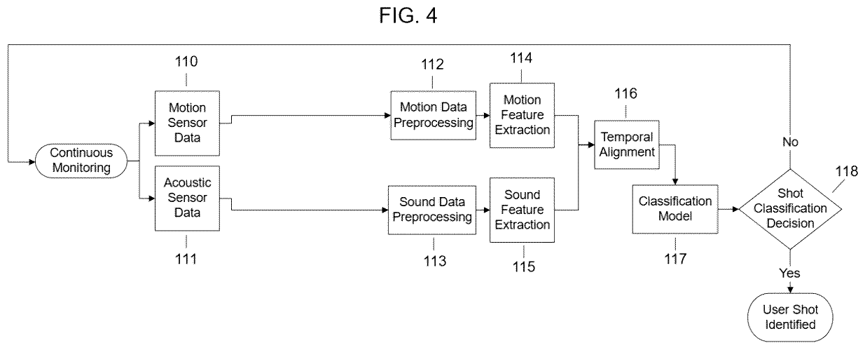

In parallel, sound sensors (102) monitor for acoustic characteristics associated with gunfire, which typically include a rapid rise in sound pressure level (less than 1 millisecond) and a distinct frequency spectrum. As shown in FIG. 4, the system continuously evaluates sensor streams for signals exceeding predefined thresholds, flagging a potential shot event when either sensor detects such a condition.

Upon identification of a potential shot event, the device captures a time window of sensor data from all active sources. This capture window typically ranges from 50 milliseconds to 500 milliseconds, depending on firearm type, mounting location, and environmental factors. Raw motion data (110), such as accelerations across X, Y, and Z axes, and raw sound data (111) are temporarily stored in buffer memory (104) for processing.

The microprocessor (105) initiates preprocessing routines (112, 113) to remove noise and normalize data for consistent interpretation across various firearm types. For motion data, preprocessing includes identification of frequency components and statistical feature extraction, such as peak acceleration, impulse duration, and energy distribution. For acoustic data, time-domain analysis identifies sharp rise times indicative of gunfire, while frequency-domain analysis (e.g., Fourier or Wavelet Transform) isolates spectral characteristics.

Following preprocessing, motion and sound features are combined using feature-level fusion techniques to create a unified event representation. Temporal alignment (116) ensures that motion features (114) and sound features (115) correspond to the same physical event. Alignment is achieved through timestamp synchronization, cross-correlation, or learned temporal offsets established during the calibration process.

This unified feature vector is input into a trained classification model (117) designed to distinguish between valid user-fired shots and false positives (118). While Support Vector Machines (SVMs) have demonstrated strong performance, alternative machine learning models such as Random Forests, Neural Networks, or ensemble methods may be employed, depending on resource availability and deployment context.

To further reduce false positives in shared environments, the system applies additional classification criteria. These may include the correlation between recoil patterns and acoustic signatures, spatial orientation based on gyroscope or GPS data, and adaptive detection thresholds that reflect user-specific and firearm-specific calibration data. This multi-stage analysis improves classification robustness without increasing processing latency.

By combining multimodal sensing, feature fusion, and a trained classification model, the system achieves accurate and reliable shot detection in real-world scenarios. The architecture allows it to outperform traditional single-sensor shot timers by maintaining high true positive rates and minimizing false detections, even in acoustically complex or high-traffic shooting environments.

The device operates on an embedded software architecture designed to support precise timing, low-latency processing, and efficient power management. The underlying real-time operating system enables deterministic execution of shot detection routines with sub-millisecond resolution, ensuring consistent performance under varied operational conditions and workloads.

To support real-time signal analysis, the device employs optimized software libraries for embedded signal processing. These libraries enable efficient execution of time-domain and frequency-domain transformations, including 256-point and 512-point Fast Fourier Transforms (FFT) with Hanning or Hamming window functions. Sampling rates typically range from 16 kHz to 44.1 kHz, and a sliding analysis window of 20 to 50 milliseconds may be applied to isolate transient events. These techniques enable high-resolution feature extraction from brief acoustic and motion signals associated with firearm discharge.

The classification model (117) is implemented using routines optimized for embedded processors and resource-constrained environments. The model operates on feature vectors composed of attributes such as time-domain peak amplitude, signal energy, zero-crossing rate, frequency band ratios, motion jerk profiles, and recoil impulse duration. These features are extracted from the fused sensor streams during preprocessing. The model may consist of a trained Support Vector Machine (SVM), decision tree ensemble, or quantized neural network. Models are trained offline using labeled datasets and deployed in fixed-point or quantized format for efficient on-device inference.

Sensor data is processed through a multi-stage pipeline that includes filtering, normalization, and temporal alignment. Preprocessing stages (112, 113) remove high-frequency noise, adjust for sensor drift, and standardize input signals across varying firearm types and mounting configurations. Motion features (114) and sound features (115) are extracted independently, then synchronized using temporal alignment logic (116) based on timestamp correlation, cross-correlation analysis, and calibration-derived offsets.

The device supports a modular firmware design, enabling over-the-air updates through the wireless communication module (108). This architecture allows for future enhancements, including the integration of new sensor modalities, additional feature extraction algorithms, or updated classification models. Firmware updates are digitally signed and validated on-device to ensure system integrity and security during deployment.

FIG. 4 illustrates the system's data flow, beginning with raw sensor acquisition and progressing through preprocessing, feature extraction, sensor fusion, classification, and final output generation. This pipeline structure ensures that each processing stage contributes to a unified and high-confidence shot event determination.

To optimize power consumption, the device utilizes a tiered power state management strategy. A low-power accelerometer continuously monitors for motion above a configurable threshold (e.g., 2.5 G over a 10 ms interval). Upon detecting such motion, a hardware interrupt is triggered, waking the main processor from a sleep state. Full data acquisition and processing are then initiated. After a user-defined timeout period (e.g., 1-5 seconds of inactivity), the system returns to standby mode to conserve energy.

This architecture balances computational performance with energy efficiency, enabling low-latency response and real-time feedback while maintaining extended battery life. The system is designed to operate continuously in training or tactical environments without frequent recharging, making it suitable for field use in both civilian and professional settings.

The device is designed to accommodate multiple physical embodiments to suit varying user preferences, firearm platforms, and operational scenarios. While the default configuration is a wrist-mounted form factor, alternative mounting locations are supported without compromising detection accuracy or data quality.

As shown in FIG. 2, the preferred embodiment involves mounting the housing (100) to a wristband, worn on the user's dominant wrist. This location maximizes sensitivity to motion signatures associated with recoil during firearm discharge. The wrist-mounted configuration is particularly effective for handguns and short-barreled rifles, where the wrist experiences significant acceleration at the moment of firing.

As illustrated in FIG. 3, alternative embodiments include firearm-mounted configurations in which the housing (100) is attached directly to the weapon system. This may be achieved using industry-standard mounting systems such as M-LOK slots, Picatinny rails, or magnetic attachment bases. Additional form factors may include integrated installations within the firearm's stock, grip, or handguard. In some embodiments, the system may be modular, consisting of detachable sensor units linked to a central processor module via wired or wireless connections. This modular approach enables sensor placement optimization for specific platforms or shooting styles.

All physical configurations preserve the device's core functional architecture, including motion and sound sensors, data fusion processor, local storage, user interface, and communication module. Embodiments may vary in size, enclosure material, or power source, but are designed to maintain full compatibility with the shot detection and analytics pipeline described herein. This physical adaptability enables the invention to support a wide range of shooting disciplines, including tactical, competitive, recreational, and professional use.

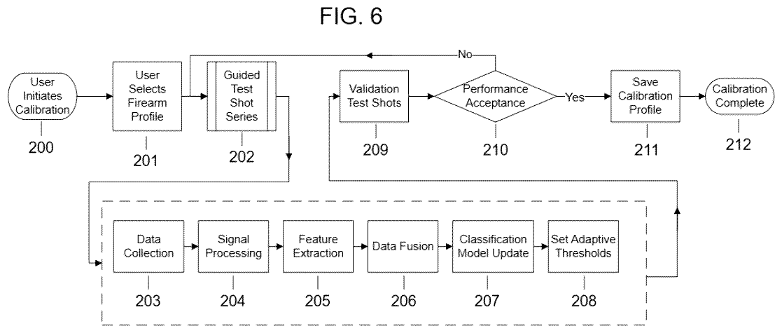

The device incorporates an adaptive calibration system designed to improve detection accuracy across a wide range of firearms and individual user characteristics. As illustrated in FIG. 6, the calibration process enables dynamic adjustment of detection parameters based on factors such as firearm type, recoil profile, and user shooting mechanics. This system enhances the fidelity of shot recognition and reduces false positives in variable real-world conditions.

Calibration is initiated either via the onboard user interface (107) or through an external device (300) connected via the wireless communication module (108). The user selects a firearm profile or initiates a new one, beginning the calibration sequence (step 200 in FIG. 6). This sequence is conducted for a specific firearm and user combination, allowing the system to adapt to individualized patterns.

The device then guides the user through a controlled series of test shots (202), using feedback signals such as haptic vibration, audio tones, or visual cues to prompt each shot. Multiple shots may be required to capture sufficient data variability. During this process, raw motion and sound data are collected and stored in buffer memory (104). Key signal features, including acceleration peaks, recoil patterns, impulse durations, and acoustic rise times—are extracted from both data streams.

Feature vectors are formed by fusing the extracted motion and acoustic data into a unified representation of each shot. These vectors are then used to adjust internal detection parameters, including model thresholds, filter coefficients, temporal alignment offsets, and feature weighting. The calibration routine may also retrain or fine-tune the classification model (117) using incremental learning or parameter updates, depending on the hardware capabilities of the device.

The adaptive calibration process accounts for several firearm- and user-specific variables, including recoil intensity, firearm balance, sound signature, trigger pull characteristics, and muzzle velocity. It also compensates for environmental influences such as ambient noise levels, temperature, and barometric pressure. In some embodiments, the device may detect significant changes in sensor input patterns and prompt recalibration to maintain optimal performance.

The calibration process is designed as a structured multi-stage sequence, as illustrated in FIG. 6. It includes the following steps:
200—Calibration Initiation: User selects or creates a firearm profile and starts the calibration.
201—Firearm Selection: The system associates the session with a specific firearm-user pairing.
202—Test Shot Series: The user fires a minimum of three test shots while the system collects raw sensor data.
203—Data Collection: The system captures motion and acoustic inputs during each shot.
204—Signal Processing: Time-domain and frequency-domain analysis is performed to extract relevant features.
205—Feature Extraction: Sensor-specific features are derived and stored.
206—Data Fusion: Features from motion and sound sensors are combined into unified vectors.
207—Model Update: The classification model is tuned or updated using the new feature data.
208—Threshold Adaptation: Detection thresholds and parameters are refined for optimal accuracy.
209—Validation Test Shots: Additional shots are analyzed to verify calibration accuracy.
210—Performance Acceptance: Detection accuracy and false positive rate are evaluated against predefined criteria.
211—Save Calibration: Once accuracy targets are met, final parameters are stored for operational use.

Calibration data-including sensor profiles, feature weightings, and model parameters—is stored in non-volatile memory (106). These records may be securely backed up and transferred across devices to maintain calibration continuity for individual users or specific firearms. The system may support versioning and rollback of calibration profiles to maintain traceability over time.

This structured and adaptive calibration process ensures the system maintains a high degree of detection accuracy, even when used across multiple firearm platforms, environmental conditions, or user behaviors. It distinguishes the invention from static threshold-based shot timers by enabling continual refinement and user-specific optimization.

The device stores shot event data along with associated sensor-derived metadata in internal non-volatile memory (106). Each shot record may include a precise timestamp with millisecond-level resolution, the fused motion and sound feature vectors, and classification confidence scores. When available, additional data may be included, such as GPS location, environmental conditions (e.g., temperature, humidity, barometric pressure), and biometric readings (e.g., heart rate). The device may also tag each record with a firearm profile identifier and ammunition metadata when previously configured by the user.

Shot data is synchronized with an external computing device (300), such as a smartphone or tablet, via the wireless communication module (108) using a low-power protocol such as Bluetooth Low Energy (BLE). Synchronization may occur automatically at predefined intervals or manually via user command. The external application serves as an extended analytics platform, providing visualization and interpretation of stored data.

The companion application may support the following features:
Session analysis, including timestamps, split times, shot counts, and classification confidence;
Drill review, including user-defined training sequences and scoring;
Environmental correlation, linking shooting metrics with conditions such as temperature or elevation;
Biometric tracking, visualizing heart rate variability or recovery time across shooting sequences;
Performance trend analysis, aggregating data over time to identify areas of improvement or degradation;
Shot mapping, which enables heatmap visualizations when paired with compatible smart targets or location data;
Social features, such as challenge modes, performance sharing, and ranked leaderboards;
Inventory management, enabling users to track round counts per firearm or ammunition batch;
Range logging, associating shot sessions with specific geographic locations or facilities.

Data collected by the system can also support advanced analytics, including predictive modeling of optimal training schedules based on physiological data, anomaly detection for identifying mechanical issues (e.g., excessive recoil variance), and technique analysis derived from accelerometer waveform consistency. Machine learning models may be used within the app or on the device to identify early indicators of performance plateaus, fatigue, or deviation from calibrated norms.

By combining onboard sensing with an extensible analytics platform, the system enables a data-rich feedback loop for firearm users. Unlike conventional shot timers, which provide only basic event timing, this invention offers users contextual insight into how environmental and physiological variables affect shooting performance. The system also supports continuous performance monitoring over time, facilitating long-term improvement, coaching, and system maintenance.

The present invention offers several advantages over conventional shot timing and performance tracking systems. By leveraging synchronized multi-sensor data, real-time processing, and machine learning classification, the device improves shot detection accuracy in environments with multiple shooters—where false positives are common in single-sensor systems. Additionally, the system provides a high-resolution record of each shot event, including environmental, biometric, and contextual data, enabling performance analysis that extends far beyond basic timing metrics.

The system is designed for adaptability across a broad range of firearms, shooting styles, and user preferences. This includes support for both wearable and firearm-mounted configurations, dynamic calibration routines for firearm-specific profiles, and extensible analytics through a companion software application. As a result, the invention is suitable for use in a variety of domains, including:
Competitive shooting and match preparation;
Law enforcement training and qualification;
Military marksmanship and readiness evaluation;
Recreational shooting and skill development;
Coaching, instruction, and performance diagnostics.

The invention further supports integration into broader training ecosystems by enabling data sharing, interoperability with smart target systems, and export of structured shot logs for review and certification. Because data is captured and processed at the device level and then enhanced through application-level analytics, the system can be deployed in connected or disconnected environments.

Although the device uses sensor types that are generally known—such as accelerometers, microphones, and GPS receivers—the invention lies in the novel combination and application of these sensors to the specific problem of user-specific shot detection. The synchronized sensor fusion, machine learning classification pipeline, adaptive calibration methods, and field-deployable physical form factors collectively distinguish the invention from existing solutions.

The system performs tangible operations on real-world sensor data and produces concrete, real-time results in the form of validated shot events and analytical feedback. As such, the invention is directed to a specific, practical application and does not preempt any abstract idea. The disclosed system improves the operation of firearm training and monitoring equipment itself, satisfying the eligibility criteria under 35 U.S.C. § 101.

In summary, the disclosed multi-sensor shot detection system introduces a robust and extensible platform for accurate, user-specific shot detection, real-time performance tracking, and long-term analytics. The combination of wearable and weapon-mounted options, machine learning-based detection, adaptive calibration, and external data integration establishes the system as a comprehensive solution for modern firearm training and evaluation.

1. A multi-sensor shot detection device comprising:
(a) a housing;
(b) at least one motion sensor disposed within the housing and configured to detect motion associated with firearm discharge;
(c) at least one sound sensor disposed within the housing and configured to detect acoustic signals associated with firearm discharge;
(d) a microprocessor operatively coupled to the motion sensor and the sound sensor and configured to:
(i) receive and preprocess motion data and sound data from the respective sensors;
(ii) fuse the motion data and sound data into a unified feature vector;
(iii) apply a trained classification model to the unified feature vector to determine whether a valid shot event has occurred; and
(iv) determine whether the shot event was initiated by a user of the device or is attributable to ambient gunfire;
(e) a buffer memory configured to temporarily store raw motion and sound data prior to processing by the microprocessor;
(f) non-volatile memory configured to store processed data associated with detected shot events; and
(g) wireless communication module configured to transmit the stored data to an external computing device for analysis or review.

2. The device of claim 1, further comprising at least one biometric sensor, environmental sensor, or geolocation sensor operatively coupled to the microprocessor and configured to provide supplemental context data for each shot event.

3. The device of claim 1, wherein the microprocessor is further configured to execute an adaptive calibration routine comprising:
(a) shot event data from a guided calibration sequence;
(b) extracting motion and acoustic features from the sequence; and
(c) updating one or more detection thresholds or model parameters based on the extracted features.

4. The device of claim 3, wherein the adaptive calibration routine is initiated via a user interface or through a paired external device.

5. The device of claim 1, wherein the trained classification model comprises a support vector machine, decision tree ensemble, or neural network trained to distinguish between user-initiated gunfire and ambient gunfire.

6. The device of claim 1, wherein the housing is configured to be mounted on the user's body, including on a wristband, clip, or wearable accessory.

7. The device of claim 1, wherein the housing is configured to be mounted on a firearm using a mounting interface selected from the group consisting of: M-LOK, Picatinny rail, or magnetic attachment.

8. The device of claim 1, further comprising a user interface including a display configured to present information selected from the group consisting of: shots fired, shot times, drill steps, configuration menus, or performance indicators.

9. The device of claim 1, wherein the wireless communication module supports synchronization with a mobile or desktop application for data visualization, performance tracking, and historical analytics.

10. The device of claim 1, wherein the microprocessor is further configured to selectively activate high-power components in response to threshold-based triggers from the motion sensor or sound sensor to optimize power consumption.

11. The device of claim 1, wherein the microprocessor is further configured to temporally align the motion data and sound data prior to applying the classification model, based on timestamp correlation or cross-correlation analysis.

12. The device of claim 3, wherein the adaptive calibration routine further comprises performing one or more validation test shots, computing detection accuracy metrics, and storing final calibration parameters upon meeting predefined performance criteria.

13. The device of claim 1, wherein the buffer memory stores a time-bounded window of raw motion and sound data for each potential shot event prior to classification.

14. A method for detecting user-initiated firearm discharges using a multi-sensor wearable or mountable device, the method comprising:
(a) capturing motion data from at least one motion sensor;
(b) acoustic data from at least one sound sensor;
(c) storing a time-bounded window of motion and acoustic data in a buffer memory;
(d) preprocessing the motion data and acoustic data to remove noise and normalize features;
(e) fusing the motion and acoustic data into a unified feature vector;
(f) temporally aligning the fused data based on timestamps or cross-correlation;
(g) applying a trained classification model to the fused feature vector;
(h) determining whether the detected event corresponds to a valid shot initiated by the user; and
(i) recording the validated shot event in memory for synchronization with an external computing device.

15. A method for adaptively calibrating a firearm shot detection device, the method comprising:
(a) initiating a calibration session for a selected firearm and user profile;
(b) guiding a user through a series of test shots using haptic, visual, or audio cues;
(c) capturing motion and acoustic data from the respective sensors for each test shot;
(d) extracting motion features and acoustic features from the captured data;
(e) fusing the extracted features into a unified calibration vector;
(f) updating the classification model and one or more detection thresholds based on the calibration vector;
(g) performing one or more validation test shots to assess calibration performance; and
(h) storing the final calibration parameters in non-volatile memory upon meeting predefined performance acceptance criteria.
